(19) United States
(12) Patent Application Publication
(10) Pub. No.: US 2004/0170745 A1
(43) Pub. Date: Sep. 2, 2004

(54) Extruded dry and semi-dry sausage product processing and to products thereform

(76) Inventor: Kyle A. Newkirk, St. Michael, MN (US)

Correspondence Address: GENERAL MILLS, INC., P.O. BOX 1113, MINNEAPOLIS, MN, 55440, US

(21) Appl. No.: 10/375,281

(22) Filed: Feb. 27, 2003

(51) Int. Cl. A23L 1/31

(52) U.S. Cl. 426/646

(57) ABSTRACT

The present invention provides a process for rapidly producing dry and/or semi-dry sausage products through the use of a single extrusion step that is capable of both drying and cooking the sausage product. The present invention is capable of production of non-conventionally shaped sausage products for use as food and pizza toppings, snacks and ready to eat meal pieces.

### CROSS-REFERENCES TO RELATED APPLICATIONS

None.

### FIELD OF THE INVENTION

The present invention relates in general to the rapid preparation of extruded dry and semi-dry sausage products and, more particularly, to the rapid preparation of dry and semi-dry sausage products that can be extruded in particular shapes or dimensions for the purpose of creating snack size or ready-to eat pieces, unique and conventionally shaped pizza toppings and the like.

### BACKGROUND OF THE INVENTION

Dry and semi-dry sausage products are classified by the United States Department of Agriculture (“USDA”) according to their processing conditions, finished product pH, product moisture to protein ratio and various other factors. For example, in order to meet the criteria for pepperoni, the product must have a finished product moisture to protein ratio of about 1.6 to 1 and be processed under conditions specified by the USDA sufficient to kill trichinae, a harmful parasite. In order to meet the criteria for beef summer sausage, the product must have a finished product moisture to protein ratio of about 3.1 to 1 and a finished product pH of not greater than 5.0.

A conventional process for making dry and semi-dry sausage products typically includes the following steps:

(1) Admixing ground meat (pork, beef and/or poultry) with spices, curing agents and acid-producing bacteria, e.g., lactic acid-producing bacteria. Additional sources of acid such as encapsulated citric acid can also be used. The exact types and amounts of meat, spices, curing agents and sources of acid employed depend upon the type of sausage product desired. Dry sausages may or may not be characterized by a bacterial fermentation.

Next, according to conventional processing techniques, the meat mixture is formed into the desired shape by stuffing the mixture into casings of prepared animal intestine or synthetic material which are tied or sealed shut at both ends to form a single cylindrical unit or tied or sealed at intervals to form lengths. The mixture must be formed into the appropriate shape before a significant amount of acid is produced by the bacteria, released by the encapsulating material or otherwise imparted to the admixture. The acid lowers the pH of the admixture making the meat non-pliable and difficult to shape. The meat is generally easier to work with at a pH above 5.3.

Then the formed product is set in a fermenting chamber at a temperature and for a period of time sufficient for enough acid to be produced by the bacteria, released by the encapsulating material or otherwise imparted to the admixture to lower the pH of the admixture to a pH value of below 5.2, typically below 5.0. The low pH level prevents further bacterial growth and otherwise makes the product biologically stable. It also produces an acidic flavor and sets the protein in the meat thereby giving the product a firm texture. The temperature in the fermentation chamber is typically maintained between 60° F. and 105° F. for about 7 to 14 hours.

Finally, the product is dried for a period of time sufficient to obtain the required finished product moisture to protein ratio (e.g., for pepperoni, 1.6:1). For dry sausage products, the drying step must be carried out under conditions, which allow slow, controlled, uniform removal of the moisture from the product while still inhibiting the growth of surface mold or yeast. For example, the drying chamber is typically maintained at a temperature between 50° F. and 70° F. and kept relatively dry to inhibit the growth of mold or yeast. It generally requires several days or even weeks to reach the required finished product moisture to protein ratio depending upon the thickness of the formed product and other process conditions.

Some dry sausage is smoked prior to being dried but the primary production step is a relatively long, continuous air-drying process. Dry sausage typically requires more production time than other types of sausage. Dry sausage generally ranges from about 60% to about 80% of its original weight when sold. Semi-dry sausage is usually heated in a smokehouse to fully cook and partially dry the product.

Unfortunately, maintenance of the required conditions during the extended fermenting and drying steps can make mass production of dry and semi-dry sausage products somewhat difficult. Thus, there is a need for a more economical and expeditious process for making dry and semi-dry sausage products.

U.S. Pat. No. 5,736,186 to Holdren (incorporated herein by reference) discloses dry and semi-dry sausage products generally comprising highly seasoned mixtures of finely divided pork, beef and/or poultry that have been formed into a desired shape and cured. Examples of dry sausage products include pepperoni, dry salami and genoa. Examples of semi-dry sausage products include beef summer sausage, thuringer and sicilian salami. This document discloses products and a process for the preparation of a semi-dry sausage product over a very much-reduced time frame, without the need for any fermentation step.

The process described in U.S. Pat. No. 5,736,186 involves mixing meat with an encapsulated acidulant. The encapsulating material has a melting temperature of at least 90° F. The sausage mixture is formed optionally by extrusion into small pieces with a cross section no greater than 1 inch. The pieces are then heated for no more than 1 hour at a temperature from 90° F. to 500° F. This temperature melts the encapsulating material and allows the acidulant to contact the meat and lower the pH to less than 5.3, and dehydrates the product.

The process does not rely on the use of acid producing bacteria and therefore no fermentation step is required. The extrusion step, when employed in the process provides a means of producing non-conventional product shapes. The encapsulation of the acidulant in the admixture makes the admixture readily formable because the meat is soft and pliable and readily extruded.

However, U.S. Pat. No. 5,736,186 does not teach the use of an extrusion step that forms and cooks the sausage products. Nor does U.S. Pat. No. 5,736,186 teach the use of a non-encapsulated acidulant because the purpose behind the U.S. Pat. No. 5,736,186 is the prevention of the meat coming in contact with the acidulant during extrusion.

In accordance with the invention, an improved and expeditious process for producing dry and semi-dry sausage products has been developed. The process allows dry and semi-dry sausage products to be produced in commercially significant quantities in a matter of 2 to 3 hours as opposed to multiple days or weeks. The inventive process is particularly useful for producing pepperoni pieces suitably shaped and dimensioned for snack size or ready-to eat pieces or pizza toppings as well as pieces that may have a unique configuration or appearance, such as a animate object, character or ornate configuration.

### BRIEF SUMMARY OF THE INVENTION

The invention combines several pieces of technology into a production system to rapidly manufacture by way of extrusion dry or semi dry sausage pieces. The process of the invention utilizes a single or twin-screw extrusion process to form and cook a mixture of meat and ingredients into dry or semidry sausage pieces. The traditional fermentation step used in making pepperoni is replaced by an acidulation step, preferably using a non-encapsulated acidulant to minimize the time required in preparing the desired end product. These pieces are then further dried to meet the United States Department of Agriculture (“USDA”) requirements. The process can be utilized to produce novel shaped pieces for dry or semi dry sausage, such as pepperoni pieces that are suitable for use on pizza toppings and may accompany a theme or promotion of the manufacture. For example, the pieces may be provided in geometric patterns such as stars, squares, pentagonals, hexagonals, and the like as well characters such as might appear in electronic games or in advertising or animate objects.

It is a primary object of this invention to provide a significantly reduced processing time for traditional pepperoni that reduces the overall time necessary to prepare the product from several days to desirably less than 3 hours. The reduced time frame significantly decreases the costs and enables increased throughput. As such, the resulting extruded semi-dry or dry extruded product can be formed into several shapes suitable for use as pizza toppings, food toppings or snack packs. The shapes may be cut in 2 or 3 dimensions from a sheet of suitably extruded dry and semi-dry sausage product.

To accomplish these and other related objects of the invention, in one aspect, the invention provides a process for rapidly producing at least one dry and semi-dry sausage product comprising the steps of first admixing an amount of ground meat with an amount of an edible acidulant to form a sausage admixture, then extruding the sausage admixture into at least one shaped sausage product; and finally drying the shaped sausage product to achieve a desired water to protein ratio, such that during the extrusion step the sausage admixture is simultaneously formed and cooked into the desired end sausage product.

Preferably, the overall process time involved under the present invention for producing the sausage product is less than 3 hours and is most preferably will run as a continuous process. The extrusion step is conducted at a temperature range of about 130° F. to about 170° F. to achieve effective cooking of the sausage admixture. The size and shape of the sausage product has at least one cross-sectional dimension between about 1/16 of an inch to about 2 inches. In the present exemplary embodiment, the drying step takes between about 30 to 50 minutes and is usually conducted at a temperature of between about 150° F. to about 225° F. in order to achieve effective drying of the sausage product. It has been found that drying at this temperature and for the stated duration it is possible to achieve the desired water to protein ratio of the sausage product which ranges between about 0.75:1 to about 3.2:1 by weight, or in the case of pepperoni products, preferably about 1.6:1.0 by weight.

The ground meat that is preferably used is selected from pork, beef and poultry (chicken, turkey, etc.), or mixtures thereof. Other combinations are of course possible, including alligator, bison, bear, elk, deer, ostrich, game birds and other fowl, etc. The grade of meat that is used in this process may optionally be less than that of traditional semi-dry or dry sausage products without sacrificing flavor.

The edible acidulant that may be used in the process may be selected from glucano-δ-lactone, lactic, malic, citric, acetic, isoascorbic, adipic, tartaric, sorbic acid and mixtures thereof. The preferred amount of ground meat to the amount of acidulant ratio is between about 99:1 to about 95:5 by weight.

Once the product has been extruded and cooked the sausage product is preferably sliced/diced or cut into two dimension or three-dimensional shaped pieces that are adapted in size and suitable for use for snacks or pizza or food toppings.

The resulting products of the process may be further processed for packaging and freezing the sausage product as may be required for shipping, distribution or storage.

Additionally, the process may further include the steps of removing any scrap product arising from the forming step, regrinding and admixing with an acidulant and further processing according to the steps identified above (extruding and then drying the sausage).

In another aspect, the invention is related to a semi-dry or dry sausage product that is produced in accordance with the method defined above.

In an exemplary embodiment, the semi-dry or dry sausage product is selected from beef summer sausage; thuringer, sicllian salami, pepperoni, dry salami or genoa, and is shaped and dimensioned into snack size or ready-to eat pieces, or most preferably is formed into shapes suitable for use in pizza or other food toppings. In the present example, the dry sausage product is pepperoni.

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 provides a high level flow diagram of a preferred embodiment of the present invention; and

FIG. 2 depicts a variety of shapes in which the product produced by the current process may be provided.

### DETAILED DESCRIPTION OF THE INVENTION

The present invention is now illustrated in greater detail by way of the following detailed description, but it should be understood that the present invention is not to be construed as being limited thereto.

The present invention utilizes a single or twin-screw extrusion to cook and form a mixture of meat and ingredients into pieces of semi-dry or dry sausage products, such as pepperoni. These pieces of sausage products such as pepperoni can be in many shapes, including square, round, star and other geometric shapes as well as other shapes such as animate objects, popular characters or themed shapes, can then be dried in a secondary step to a level that would meet the USDA requirement for pepperoni.

In accordance with an exemplary embodiment of the inventive process, meat, such as pork, poultry and beef is first admixed with an acidulant to form a sausage admixture. The type of meat used depends upon the type of dry or semi-dry sausage product desired. Examples of meats that can be used include fresh and frozen pork, beef, and/or poultry. Certain other meats as well can also be included in association with particular products. The amount of fat present in the meat is also a factor. The amount of fat needed varies depending upon the type of product, flavor, etc. that is desired in the end product. For example, for pepperoni, meat consisting of at least about 90% by weight based on the total weight of the meat of finally divided raw meat selected from pork, beef, poultry and mixtures thereof, and having a total meat fat content no greater than about 58% by weight based on the total weight of the meat is very suitable. Under high temperatures or even under microwave conditions, the fat tends to melt and renders the resulting meat product unsatisfactory. It is important in the present invention to minimize the amount of fat lost from the meat and to ensure that the ability of the meat product to bind when extruded is maintained.

As used herein and in the appended claims, the term “acidulant” denotes any food grade acid as well as compounds, which react with water to generate food grade acids such as glucono-δ-lactone. A food grade acid is an acid, which is suitable for human consumption, United States purity grade and approved by the USDA. Examples of food grade acids that can be used include citric acid, lactic acid, acetic acid, sorbic acid, tartaric acid, isoascorbic acid, adipic acid and mixtures thereof. The acidulant used in connection with the present invention is preferably selected from the group consisting of glucano-δ-lactone, lactic, malic, citric, acetic, isoascorbic, adipic, tartaric, sorbic acid and mixtures thereof. The acidulant and the preferred amount of ground meat to the amount of acidulant ratio ranges between about 99:1 to about 95:5 by weight.

The acidulant must be used in an amount and have a strength sufficient to lower the pH of the sausage admixture to a value no greater than about 5.3 in the resulting meat product. Preferably, the acidulant is used in an amount and has a strength sufficient to lower the pH of the sausage admixture to a value between about 5.0 and about 4.1. The exact pH will vary depending in part on the type of sausage product, flavor desired, and the like. For example, for pepperoni, the acidulant is preferably employed in an amount and has a strength sufficient to lower the pH of the sausage admixture to a value of about 4.3. Such a low pH enhances the flavor of pepperoni.

The exact amount of the acidulant required depends in part on the initial pH of the meat, the desired pH of the meat, the buffering capacity of the meat, the type and amount of additives admixed with the meat and the strength of the specific acidulant used. Generally, the amount of acidulant that must be employed is in the range of from about 1% by weight to about 5% by weight based on the weight of the meat.

One or more spices, seasonings and one or more curing agents may also be optionally employed in the sausage admixture. These ingredients are preferably admixed with the ground meat at the general time the acidulant is admixed with the meat. The particular spice(s) and/or curing agent(s) employed depend on the end product desired. Examples of spices that can be used include white pepper, anise, fennel, red pepper, oregano, black pepper and mixtures thereof. Examples of curing agents that can be used include sodium nitrite, sodium erythorbate, potassium nitrite, potassium nitrate, sodium nitrate and mixtures thereof. If spices are used, they are generally employed in a total amount of from about 1% to about 6% by weight based on the weight of the meat. The amount of the curing agents used varies depending on the particular agent(s). For example, sodium nitrite and potassium nitrite are each used in an amount of 0.25 ounces per 100 pounds of meat. Sodium nitrate and potassium nitrate are each used in an amount of 2.75 ounces per 100 pounds of meat. The curing agents function to retain substantially the original meat color and kill trichinae.

Additional ingredients including binders and extenders can be admixed with the meat as known to those skilled in the art of sausage making. Such additional ingredients are preferably added to the sausage admixture at about the same time the acidulant, spices, curing agents and/or protein source are admixed with the meat.

It will be appreciated that the acidulant, spice(s), curing agent(s), protein source and any other ingredients employed can be admixed with the meat by any method that uniformly distributes the ingredients throughout the meat. In the present invention, a conventional meat blender can be employed. Generally, about 2 to about 5 minutes mixing time is sufficient. The meat is typically provided in a chopped, ground, diced, minced or otherwise finely divided condition, however, for the purposes of this invention, the meat is provided in a most preferably ground condition, prior to admixing the acidulant and other ingredients therewith. A suitable sausage as provided in the exemplary embodiment is obtained through the admixture which includes the ground meat, then blending the ground meat with the acidulant and other ingredients to form the sausage admixture and then grinding the entire sausage admixture prior to the forming step.

Once the meat is admixed with the encapsulated acidulant and any other ingredients employed to form a sausage admixture, the sausage admixture is extruded and simultaneously cooked into at least one shaped sausage product, preferably a plurality of shaped sausage products (such as a plurality of nuggets, tubes, links or the like). Each shaped sausage product formed must have a thickness and overall shape that allows sufficient heat exchange and moisture transfer in the subsequent drying step. It has been found that sufficient heat exchange and moisture transfer in the drying step can be achieved if each sausage product formed has at least one cross-sectional dimension (e.g., length, width, height, diameter) no greater than 2 inches. Each shaped sausage product formed preferably has at least one cross-sectional dimension no greater than 1 inch, more preferably at least one cross-sectional dimension in the range of from about 1/16^{th} inch to about ½ inch.

In one embodiment, the sausage admixture is formed into a plurality of sausage products, in either sheets or strips each having at least one cross-sectional dimension no greater than approximately 1 inch, preferably no greater than about ½ inch.

Once the product has been extruded and cooked the resulting sausage products can then be further optionally cut/sliced or diced into smaller shaped two dimensional or three dimensional products prior to the drying step. Conventional cutting/slicing or dicing equipment may be used. Preferably the process may be utilized to produce novel shaped pieces for dry or semi dry sausage, such as pepperoni pieces that are snack sized, or pepperoni pieces that are suitable for use as pizza or other food toppings.

The extrusion device that is employed for the invention can be achieved using a simple extruder such as a VeMag-type stuffer. While the invention can utilize a single or twin-screw extruder, a twin-screw extruder is preferred. The inventors have found that the pressure at which the extrusion step is conducted is not an important aspect of the process and that it is possible to achieve well-extruded products with good surface properties at high extrusion rates such as up to 5000 pounds per hour. The temperature at which the extrusion process is conducted is preferably between the range of about 20° F. to about 120° F.

In general, the smaller the dimensions of the shaped sausage product(s) formed the greater the rate of heat penetration and moisture removal achieved in the heating step. As such, through use of the present invention the nature of the extrusion process facilitates the production of nuggets and other sausage products having non-conventional shapes thereby permitting the manufacturer to further differentiate its products in the marketplace.

Once the sausage admixture is formed into one or more shaped sausage products, the product(s) are heated and dried until the desired moisture to protein ratio in the product is achieved. In the present exemplary embodiment, the drying time is less than 1 hour and that the drying temperature is conducted at a temperature of between about 150° F. to about 225° F. More preferably, the drying temperature is conducted in a range between about 170° F. to about 210° F.

For sausage that contains pork, it is important to heat the product(s) at a temperature and for a period of time that is also sufficient to assure that trichinae and any harmful bacteria is destroyed in accordance with U.S.D.A. regulations. For example, for pepperoni, it is necessary to heat the product(s) at a temperature and for a period of time sufficient to raise the internal temperature of the product(s) to at least about 150° F. and more preferably to at least about 170° F. Trichinae is destroyed in accordance with the inventive process by the curing and heating aspects of the current inventive process. USDA prescribed treatments of pork and products containing pork are set forth in the Code of Federal Regulations, Section 318.10 (May, 1985), which is incorporated by reference herein.

It will be appreciated that the length of time of the heating/drying step will vary depending on many process parameters and factors including the type of product(s) being produced and the particular requirements therefor, including the initial amount of moisture in the product(s), the shape of the product(s) being heated, the temperature being used and the type of heating apparatus being used.

The required finished product moisture to product ratio for various types of dry and semi-dry sausage products is shown below.

| Product | Moisture to Protein Ratio |
|---|---|
| Beef summer sausage | 3.1:1 |
| Pepperoni | 1.6:1 |
| Jerky | 0.75:1 |
| Dry sausage | 1.9:1 |
| Thuringer | 3.7:1 |
| Dry salami | 1.9:1 |
| Genoa salami | 2.3:1 |
| Farmer summer sausage | 1.9:1 |

The drying step can be carried out using many different types of heating devices, including but not limited to linear forced air dryers/oven, vacuum dryers, spiral forced air dryers, batch ovens and the like.

Once the drying step is completed, any dried off cuts resulting from the slicing, dicing or cutting step can be separated and removed from the desired products. The off cuts can then be fed back into the process as a protein source that can be ground up with the next batch of meat destined for processing in a further cycle of the process.

The remaining dried and suitably shaped products can then be packaged, chilled, optionally frozen and shipped/stored as required.

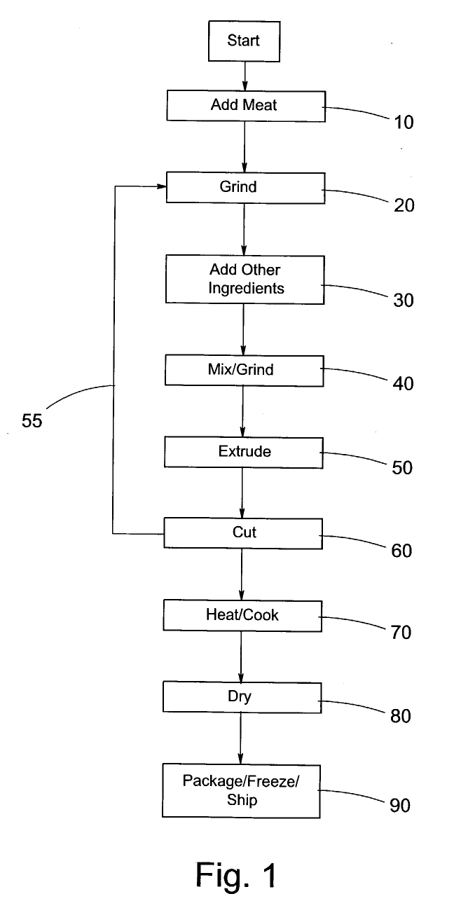

In a preferred embodiment, the inventive process as illustrated in FIG. 1 is employed on a continuous basis to mass-produce dry or semi-dry sausage products. First meat is added to at step 10. The meat is then ground at step 20. Next, additional ingredients including an acidulent, spices, etc. are added to the ground meat at step 30. The mixture is again ground and mixed at step 40. Next, the mixture is extruded at step 50 into casings as described above. The extruded material is cut at step 60 and cuttings are fed back or “recycled” via a pipe, conveyor, vacuum tube or the like illustrated as line 55 to the grinding step 20. After the extrudate is cut, it is then heated at step 70, dried at step 80 to produce a finished product. It should be understood that the heating and drying step preferably occur simultaneously but are illustrated in FIG. 1 as separate steps for convenience. The product may be prepared for packaging, freezing or distribution at step 90.

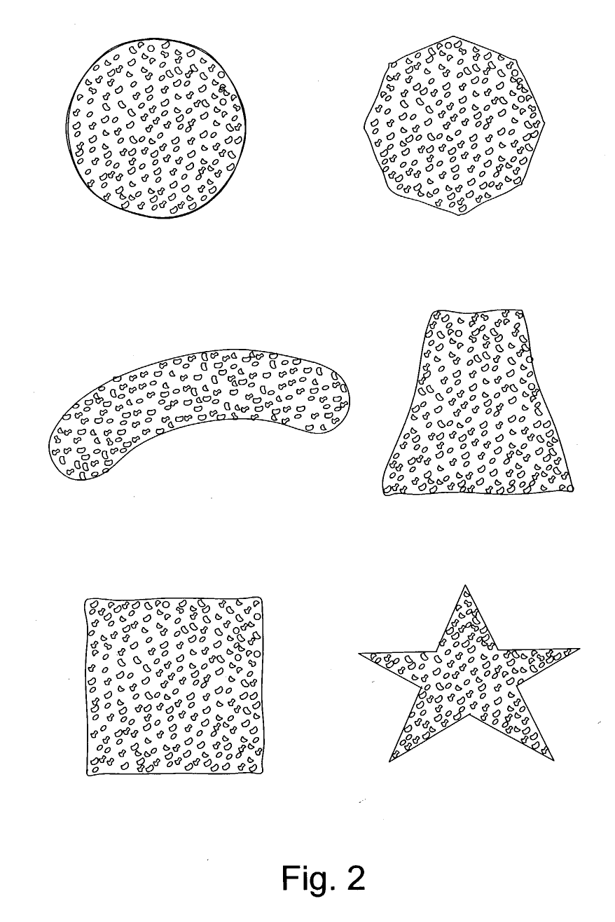

Turning briefly to FIG. 2, the illustration depicts a number of configurations and shapes that may be produced in connection with the present embodiment. Other configurations, shapes, designs, etc. are of course possible.

In order to further illustrate the inventive process, the following examples are given. Although the examples are presented to illustrate certain specific embodiments of the invention, they are not to be construed to restrict the scope and spirit of the invention.

### EXAMPLE I

A sample of dry sausage (pepperoni) was produced in accordance with the inventive process.

First, the meat, approximately 5 kg, was ground (step 20) and then admixed with the other ingredients including an acidulant, spices, seasonings, a curing agent and a protein source to form a sausage admixture (steps 30 and 40 in FIG. 1). The meat consisted of a mix of beef and pork in a range of approximately 30% beef and 70% pork. The beef and pork were ground together in a conventional meat grinder prior to being admixed with the other ingredients. The total fat content in the meat was about 35% by weight based on the weight of the meat (meat referring to the meat mix).

The acidulant is a combination of citric and lactic acid and was used in an amount by weight relative to the meat of approximately 1.5% each.

The spices and seasonings used were conventional sausage or Italian seasonings obtained from Chris Hanson Corp. and included approximately 5% by weight of the batch prepared.

The ground meat mix was admixed with the acidulant, spices, seasonings, curing agent in a conventional meat blender for approximately 4 minutes.

Next, the sausage admixture was continuously extruded into a plurality of rectangular strips, each strip being approximately 4 inches wide and ⅜ of an inch high. The strips were extruded by loading the sausage admixture into an extrusion chamber and using a piston to push the admixture through an extrusion head.

The resulting extruded sausage product was then cut into shapes or pieces having the following dimensions one and half inches (½″) by one and half inches (½″).

The heating device through which the pepperoni pieces were dried was a batch oven operating at a temperature of approximately 150° F. and the time required for drying was approximately 30 minutes.

A few of the pieces were analyzed upon exiting the oven. The pieces looked and tasted like conventional pepperoni, had a pH level of around 4.3 and a moisture to protein ratio of 1.6:1 or less.

### EXAMPLE II

An additional sample of dry sausage (pepperoni) was produced in accordance with the inventive process.

First, the meat, approximately 5 kg, was ground and then admixed with an acidulant, spices, seasonings, a curing agent and a protein source to form a sausage admixture. The meat consisted of a mix beef and pork in an amount of about 30% beef and about 70% pork. The beef and pork were ground together in a conventional meat grinder prior to being admixed with the other ingredients. The total fat content in the meat was about 33% by weight based on the weight of the meat (meat referring to the meat mix).

The acidulant is a combination of citric and lactic acid and was used in an amount by weight relative to the meat of approximately 1.5% each.

The spices and seasonings used were conventional sausage or Italian seasonings obtained from Chris Hanson Corp. and included approximately 5% by weight of the batch prepared.

The ground meat mix was admixed with the acidulant, spices, seasonings, curing agent in a conventional meat blender for approximately 6 minutes.

Next, the sausage admixture was continuously extruded into a plurality of rectangular strips, each strip being approximately 4 inches wide and about ½ inches high. The strips were extruded by loading the sausage admixture into an extrusion chamber and using a piston to push the admixture through an extrusion head.

The resulting extruded sausage product was then cut into shapes or pieces having the following dimensions ¼″ by ½″ to 2″ by 2″.

The heating device through which the pepperoni pieces were dried was a batch convention oven operating at a temperature of approximately 120° F. The time required for drying was about 30 to 45 minutes.

A few of the pieces were analyzed upon exiting the oven. The pieces looked and tasted like conventional pepperoni, and had a pH level of 4.4 and a moisture to protein ratio of 1.6:1 or less.

Thus, the present invention is well adapted to carry out the objects and attain the ends and advantages mentioned as well as those, which are inherent therein. The preceding examples can be repeated with similar success by substituting the generically or specifically described components and/or operating conditions of this invention for those used in the examples.

Furthermore, although certain preferred embodiments of the invention have been described for illustrative purposes, it will be appreciated that various modifications and innovations of the process recited herein may be effected without departure from the basic principals, which underlie the invention. Changes of this type are therefore deemed to lie within the spirit and scope of the invention except as may be necessarily limited by the appended claims and reasonable equivalents thereof.

It will thus be seen according to the present invention a highly advantageous process for creating sausage products has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A process for rapidly producing dry or semi-dry sausage product comprising the steps of
i) admixing an amount of ground meat with at least an amount of an edible acidulant to form a sausage admixture,
ii) extruding the sausage admixture into at least one shaped sausage product;
iii) drying the shaped sausage product to achieve a desired water to protein ratio; and
wherein during the extrusion step the sausage admixture is simultaneously formed and cooked into the shaped sausage product.

2. The process according to claim 1, wherein processing time for producing the shaped sausage product is less than 3 hours.

3. The process according to claim 1, wherein the process is continuous.

4. The process according to claim 1 wherein the extrusion step includes an heating that is conducted at a temperature range of about 130° F. to about 170° F. to achieve effective cooking of the shaped sausage product.

5. The process according to claim 4, wherein the heating is conducted at a temperature of about 140° F. to about 160° F.

6. The process according to claim 1, further including the step of forming the cooked and extruded sausage product into desired two dimensional or two dimensional shapes and sizes.

7. The process according to claim 1, wherein the size and shape of the shaped sausage product has at least one cross-sectional dimension between about 1/16 inch to about 2 inches.

8. The process according to claim 7, wherein the size and shape of the shaped sausage product has at least one cross-sectional dimension between about ¼ inch to about 1 inch.

9. The process according to claim 1, wherein the drying step takes between about 30 to about 50 minutes.

10. The process according to claim 1, wherein the drying step takes about 35 minutes.

11. The process according to claim 1, wherein the drying step is conducted at a temperature of between about 150° F. to about 225° F. to achieve effective drying of the shaped sausage product.

12. The process according to claim 1, wherein the drying step is conducted at a temperature of between about 170° F. to about 210° F.

13. The process according to claim 1, wherein the desired water to protein ratio of the shaped sausage product is about 0.75:1 to 3.2-1.0 by weight.

14. The process according to claim 1, wherein the desired water to protein ratio of the shaped sausage product is about 1.6:1.0 by weight.

15. The process according to claim 1, wherein the ground meat is selected from pork, beef and poultry, or mixtures thereof.

16. The process according to claim 1, wherein the edible acidulant is selected from glucano-δ-lactone, lactic, malic, citric, acetic, isoascorbic, adipic, tartaric, sorbic acid and mixtures thereof.

17. The process according to claim 1, wherein the amount of ground meat to the amount of acidulant ratio is between 99:1 to 95:5 percent by weight.

18. The process according to claim 1, wherein the amount of ground meat to the amount of acidulant ratio is 97:3 percent by weight.

19. The process according to claim 1, includes the step of admixing one or more spices and/or seasonings into the ground meat/acidulant admixture prior to the extruding step.

20. The process according to claim 1, includes further steps of removing any scrap product arising from the extruding step, then regrinding and admixing with an acidulant and further processing with steps ii) and iii).

21. The process according to claim 1, includes a further step of freezing the sausage product as required for shipping or storage after the drying step.

22. The process according to claim 1, wherein the shaped sausage product formed includes any of animate, themes, characters, stars, squares, rectangles, hexagonals, pentagonals or combinations thererof.

23. A semi-dry or dry sausage product prepared according to the process recited in claim 1.

24. The semi-dry or dry sausage product according to claim 23, selected from beef summer sausage; thuringer, sicilian salami, pepperoni, dry salami or genoa.

25. The semi-dry or dry sausage product according to claim 23, which is shaped and dimensioned into snack size, toppings for food products, pizza toppings or ready-to eat pieces.

26. The semi-dry or dry sausage product according to claim 23, wherein the sausage product is pepperoni.

27. The semi-dry or dry sausage products as recited in claim 21, wherein the sausage product is provided in the shapes of any of animate, themes, characters, stars, squares, rectangles, hexagonals, pentagonals or combinations thererof.
